(19) United States
(12) Patent Application Publication
(10) Pub. No.: US 2018/0356007 A1
(43) Pub. Date: Dec. 13, 2018

(54) SNAP AND STACK RING POST

(71) Applicant: THE BOEING COMPANY, Chicago, IL (US)

(72) Inventors: Brian WATERS, Holly Hill, SC (US); Khanh BUI, Charlston, SC (US); Daniel Thomas, Summervile, SC (US)

(21) Appl. No.: 15/621,655

(22) Filed: Jun. 13, 2017

(51) Int. Cl. F16L 3/12; F16L 3/13; F16L 3/137

(52) U.S. Cl. CPC F16L 3/1222; F16L 3/23; F16L 3/137; F16L 3/13

(57) ABSTRACT

An assembly that includes a first device. The first device includes a main body and a ring disposed around the main body. The main body is provided with at least one protuberance and at least one recess, the at least one protuberance being complementary in number with the at least one recess. The first device is adapted to fit to an adjacent second device by virtue of engagement of the at least one protuberance or the at least one recess to the adjacent second device.

### BACKGROUND

The present disclosure relates in general to securing cabling and/or wiring to a support structure, which may be used within an aircraft.

Ring posts are used to secure cables or wire bundles to a support structure in a vehicle. However, such ring posts often increase weight to the vehicle in a substantial manner, as they include metallic studs to ensure proper connection of ring posts. In some vehicles, such as airplanes, hundreds, or thousands of ring posts can be used, substantially increasing the weight of the vehicle, which can add to fuel costs and the like.

Further, such conventional ring posts require labor intensive installation techniques, as the ring posts need to be installed and connected using tools. This increases manufacturing time and can limit the flexibility for design change and cable rewiring and the like because the ring posts are affixed to each other using tools.

### SUMMARY

In one embodiment, an assembly is provided that includes a first device. The first device includes a main body and a ring disposed around the main body. The main body is provided with at least one protuberance and at least one recess. The first device is adapted to fit to an adjacent second device by virtue of engagement of the at least one protuberance or the at least one recess to the adjacent second device.

In another embodiment, an apparatus for securing at least one cable to a structure is provided. The apparatus includes a main body having a first end and a second end spaced from one another, the first end defining an orifice and the second end defining a plurality of recesses in a predetermined pattern. The apparatus further includes a plurality of protuberances extending from the first end, around the orifice. The apparatus includes a ring disposed about the main body, a plurality of ribs radially spaced along an outer surface of the main body for coupling the ring and the main body to each other, a plurality of legs extending from the second end, and a detent disposed on each of the legs opposite the main body. The legs and detents are complementary to the configuration of the orifice defined by the first end of the main body.

In another embodiment, a method for securing cabling in an airplane is provided. The method includes connecting a plurality of ring posts, each ring post comprising a main body, a ring disposed around the main body, an orifice provided at one end of the main body, and at least one detent extending from the main body at an end opposite from the orifice, to each other. The connecting of the plurality of ring posts includes placing protuberances of one of the plurality of the ring posts on recesses of an other of the plurality of ring posts, and placing detents of the one of the plurality of ring posts into the orifice of the other of the plurality of the ring posts, so as to provide for a removable snap-fit assembly of ring posts. The method further includes affixing the ring posts to a support structure of the airplane, and placing cabling through the plurality of ring posts.

### BRIEF DESCRIPTION OF THE DRAWINGS

FIG. 1 shows a perspective view of a ring post in accordance with an embodiment.

FIG. 2 shows another perspective view of a ring post in accordance with an embodiment.

FIG. 3 shows a side view of a ring post in accordance with an embodiment.

FIG. 4 shows another side view of a ring post in accordance with an embodiment.

FIG. 5A shows a top view of a ring post in accordance with an embodiment.

FIG. 5B shows a bottom view of a ring post in accordance with an embodiment.

FIG. 6 shows a view of a structure including a ring post in accordance with an embodiment.

FIG. 7 shows a view of a plurality of ring posts in accordance with an embodiment.

FIG. 8 shows a flowchart of a method for securing cabling in an airplane in accordance with an embodiment.

FIG. 9 is a block diagram of aircraft production and service methodology.

FIG. 10 is a schematic perspective view of an aircraft.

### DETAILED DESCRIPTION

The following detailed description of certain embodiments will be better understood when read in conjunction with the appended drawings. It should be understood that the various embodiments are not limited to the arrangements and instrumentality shown in the drawings.

As used herein, the term “cable” or “cabling” refers to any rope-like structure of a sufficient diameter and length so as to be laid across, alongside, or suspended above a surface. While cabling comprised of a wire and electronic conducting material are within the scope of cabling as used herein, the term cabling is also intended to refer simply to any structure having the appearance of a cable, including a rope without any electrical conduction characteristics.

As used herein, the term orifice refers to any opening of a structure through which something may enter. The term orifice may include an opening that has two open ends, or one open end and one closed end. The orifice can be any applicable shape, e.g., circular, oval, square, rectangle or the like.

As used herein, the term detent refers to a device for positioning and holding one mechanical part in relation to another in a manner such that the device can be released by force applied to one of the parts.

Various embodiments provide apparatuses and methods for securing cables and/or wires to a support structure. One or more embodiments allow for an assembly that includes multiple ring posts that can be snap-fit or otherwise attached to each other. The ring posts can be stacked to an unlimited height (if laid vertically) or length (if laid horizontally or otherwise nonvertically) and can reduce the number of parts needed, as well as eliminate the need for a metallic stud to attach ring posts together.

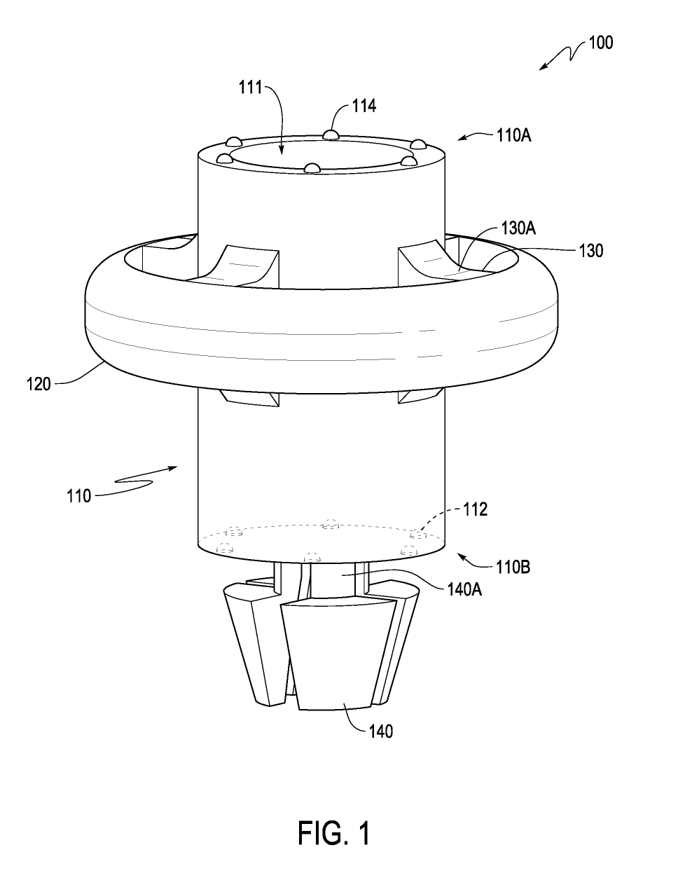

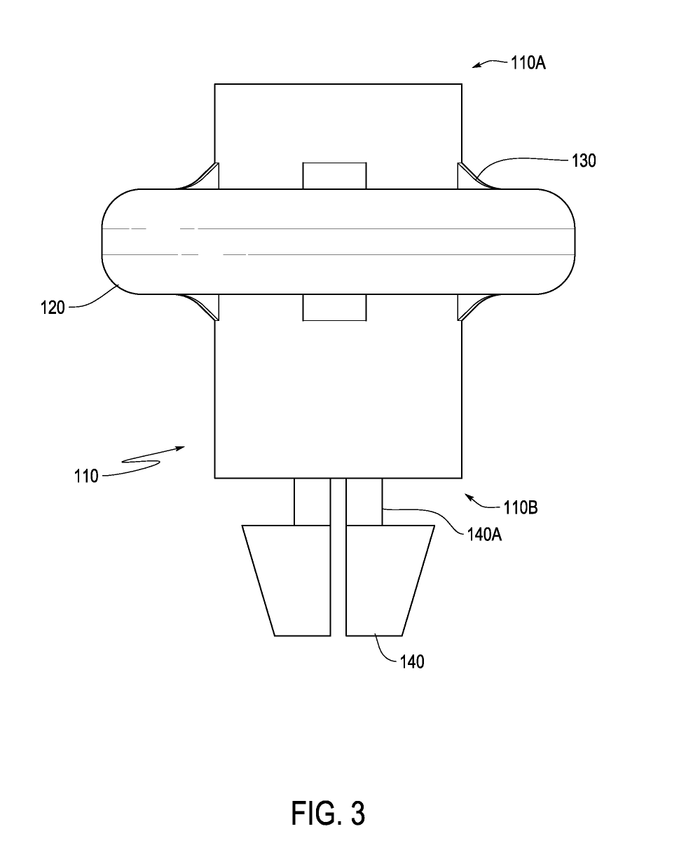

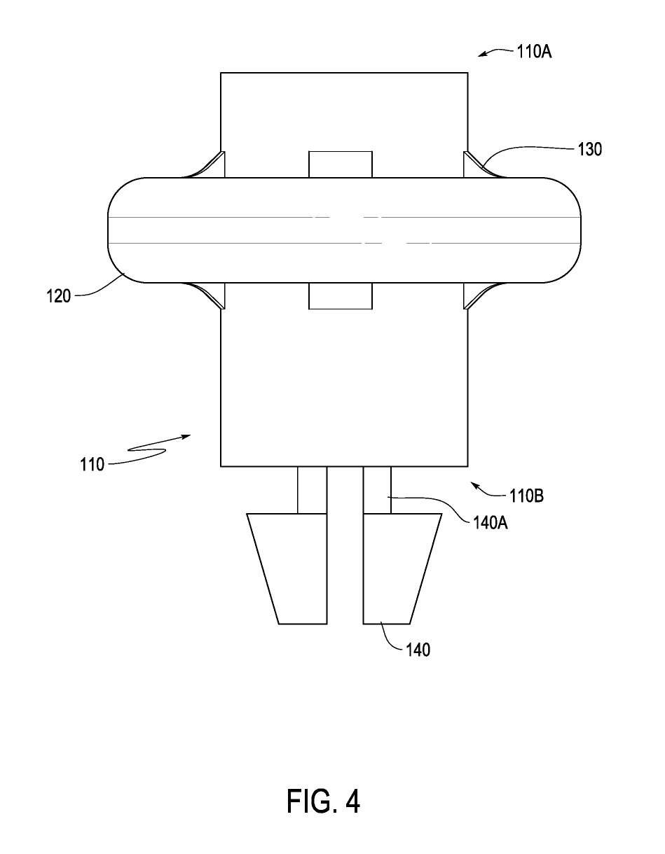

With reference to FIGS. 1-5B, an embodiment of a first device, or ring post 100, is provided. The ring post 100 may include a main body 110 and a ring 120. The main body 110 may be substantially cylindrical in nature, or otherwise may take the form of a triangular prism, rectangular prism, sphere, or other three-dimensional shape.

The ring 120 may have a ring-like circular structure and be provided of a diameter sufficient to be able to fully house the main body 110 without direct contact. In some embodiments, the main body 110 may have any suitable diameter, may be about ½ inch or more in diameter, or one inch or more, or between one and six inches. The ring 120 may have any suitable diameter, and may have a diameter large enough to fully surround the main body 110. The ring 120 may be secured to the main body 110 by means of one or more ribs 130. The ribs 130 may be staggered and/or spaced around the outer circumference of the main body 110. In some embodiments, a plurality of ribs 130 are evenly spaced, for example circumferentially spaced and radially extended around the outer circumference of the main body 110, connecting from an inner surface of the ring 120 to an outer surface of the main body 110. While the number of ribs is not particularly limited, in some embodiments four, or five, or six ribs may be used. Additionally, in one embodiment, the main body 110, ring 120 and ribs 130 may be integrally formed as a single unitary piece. In other embodiments, one or more of these elements may be separately formed and coupled to the other elements.

A longitudinal thickness at the main body 110 may be described as a first longitudinal thickness, and a longitudinal thickness at the ring 120 is a second longitudinal thickness. In some embodiments, the first longitudinal thickness being greater than the second longitudinal thickness. The ribs 130 may have a structure whereby their top surface 130A bends upward in a radial direction toward an inside of the ring post 100. That is, the portion of the ribs 130 closest to or contacting the main body 110 is disposed at a higher orientation than the portion of the ribs 130 closest to or contacting the ring 120.

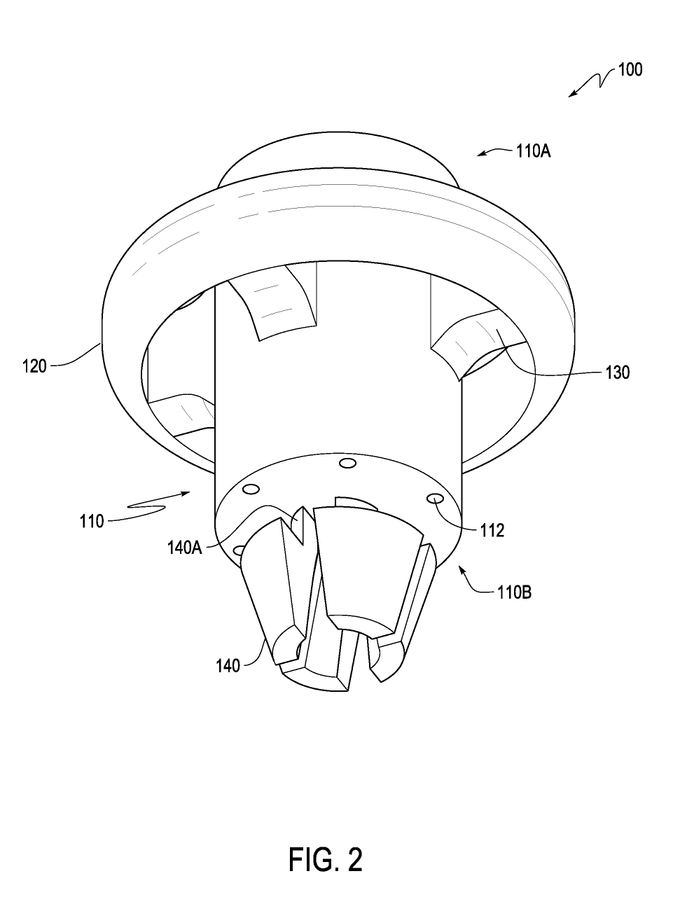

In embodiments where the main body 110 is substantially cylindrical in nature, the main body 110 can include an orifice 111 (which may be referred to as a first orifice) at one end, which may be a first end. That is, one end 110A of the main body 110 may be an open end in view of the presence of the orifice 111. The orifice 111 may extend any distance into the main body 110, so long as the space created by the orifice 111 is sufficient to house legs and detents of an adjacent ring post 100 (e.g., receive therein complementary legs and detents of an adjacent ring post) as described in more detail herein. That is, the space 110 may establish the complementary configuration to the legs and detent described in further detail below. While the orifice 111 may extend an entire length of the main body 110, the orifice 111 need not extend the entire length of the main body 110. With reference to FIG. 2, for example, the other end or a second end 110B of the main body 110 opposite the orifice may be closed.

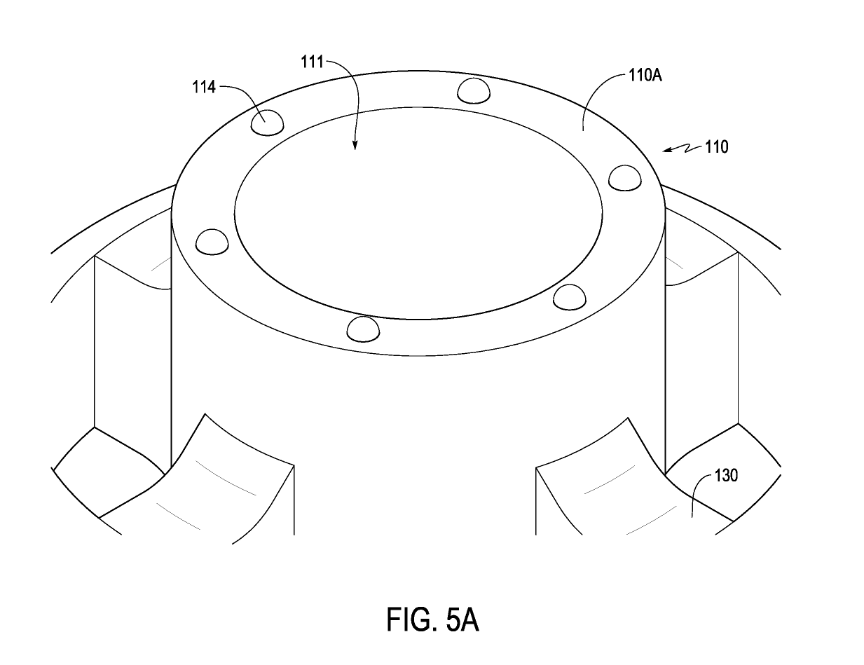

In embodiments, the main body 110 includes at least one protuberance 114 and/or at least one recess 112, which may be integrally formed. The recesses 112 and/or protuberances 114 may be formed along a rim of the end 110A or 110B of the ring post. With reference to FIGS. 1 and 5A, the protuberances 114 are shown surrounding the orifice 111 on the one end 110A of the main body 110. However, the location of the protuberances 114 is not particularly limited. The protuberances 114 may also be present, for example, along the outer circumference of the other end 110B of the main body 110. The protuberances 114 may be any protruding portion and may take different sizes and shapes. Accordingly, while the protuberances 114 are illustrated as semispherical “bumps” in FIGS. 1 and 5A, the protuberances 114 may be of different shapes and dimensions.

With reference to FIGS. 2 and 5B, the recesses 112 are shown on the other end 110B of the main body 110 (the end opposite the orifice) and are generally sized and shaped to be complementary to the size and shape of the protuberances 114 such that when brought into contact, the protuberances 114 abut or engage within respective recesses 112. Further, the number of protuberances 114 and recesses 112 may be the same in the ring post 100, and/or the number of protuberances 114 of one ring post 100 may be complementary to the number of recesses in another ring post 100. However, the number of recesses 112 and 114 need not necessarily be complementary for a particular ring post 100, or for a series of ring posts 100.

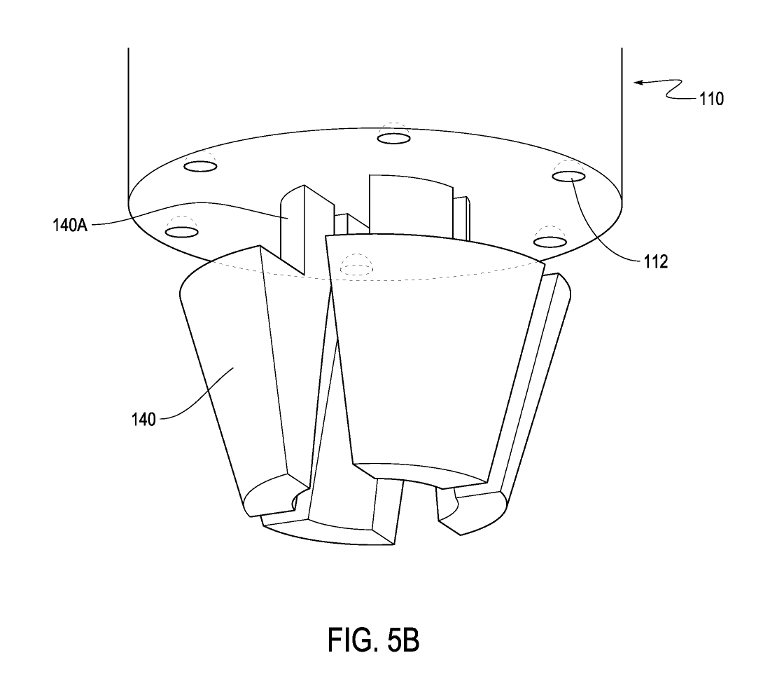

The location of the recesses are not particularly limited to the locations illustrated. Recesses may also be present, for example, along the outer circumference of the one end 110A of the main body 110. It is contemplated that in some embodiments, either or both ends 110A and 100B of the main body include both the protuberances 114 and the recesses 112, which may be arranged in different ordering as desired or needed. Thus, The number and spacing of the recesses 112 and protuberances 114 is not particularly limited. The depth of the recesses 112 are not particularly limited, provided that the recesses 112 have a depth sufficient to receive a protuberance 114 from an adjacent ring post therein so as to allow for a secure arrangement in a stacked configuration of ring posts as illustrated in FIG. 6.

On the other end 110B opposite the orifice 111, at least one leg 140A and at least one detent 140 are provided. The at least one leg 140A and at least one detent 140 are provided so as to extend from the other end 110B, in a direction away from the center of the main body 110. The at least one detent 140 is adapted to snap-fit into an orifice 111 of an adjacent ring post 100. The leg 140A is provided between the main body 110 and the detent 140.

The number of legs 140A and detents 140 is not particularly limited. However, in some embodiments, the legs 140A and detents 140 are evenly radially spaced around the circumference of the bottom surface of the other end 110B of the main body 110. In some embodiments, four, or five, or six legs 140A and detents 140 are used. The lengths and widths of the legs 140A and detents 140 are not particularly limited, provided that the combined structure 140/140A is able to snap fit into the orifice 111 of an adjacent ring post 100. The orifice 111 of the adjacent ring post for receiving the detents 140 and legs 140A may have a spacing or complementary indentation therein that allows the detents 140 and legs 140A to removably snap fit into the orifice without causing deformation or destruction of any surface of either ring post 100.

The ring post 100 may be made of a thermal plastic material, or of any other material capable of achieving the required strength while achieving a snap-fit flexibility. All portions of the ring posts 100 may be made of the same material, or materials can be selectively chosen for particular portions of the ring post 100 (e.g., legs and detents 140A/140, ring 120, main body 110) to achieve desired properties.

FIG. 6 shows embodiments of a plurality of ring posts 100 fit to each other. As should be appreciated, the alignment of the ring posts 100 may be varied such that the openings defined between the ribs 130 of adjacent ring posts 100 may be axially aligned or may be offset (e.g., offset 45 degrees). For example, the spacing of the protuberances 114 and recesses 112 may define predetermined angular offsets when coupling plural ring posts 100 together.

With reference to FIG. 6, in embodiments, the ring post 100 is connected to an adjacent ring post 100 to form an assembly (e.g., cable support and guide assembly). The ring posts 100 may be stacked immediately on top of or next to each other, or within several inches spaced from each other. In some embodiments, the ring posts 100 can be spaced approximately ¼ inch from each other in one direction, while being stacked in another direction.

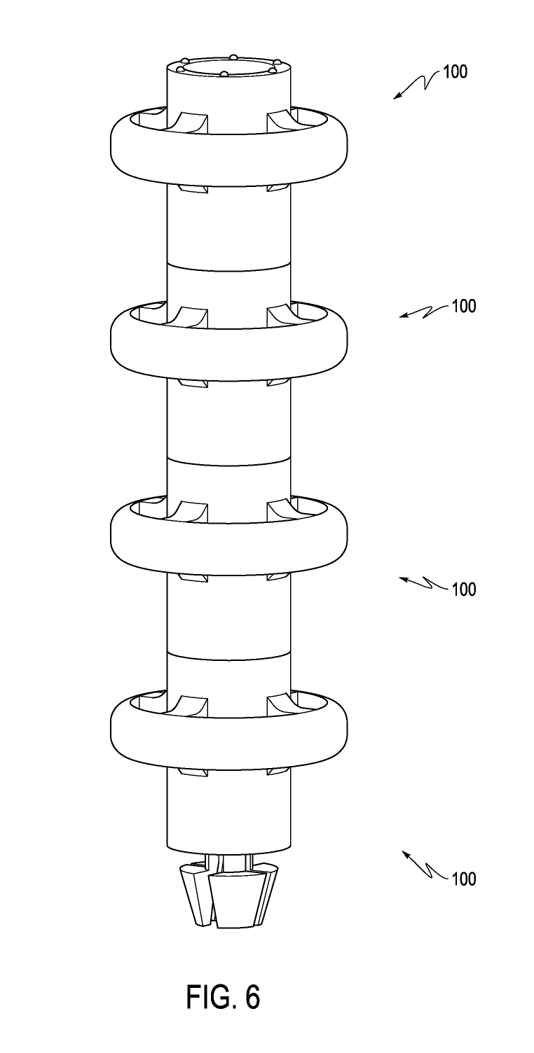

With reference to FIG. 7, cabling 200 is shown arranged within a ring post 100. The cabling 200 may be fed through a ring post 100 manually, or by machine, and may be affixed to the ring post using any mechanical means, or simply by machining the ring post 100 to have a space sufficient to house the cabling 200. The cabling 200 may also be housed within the ring post 100 with sufficient space for the cabling 200 to move freely without becoming separated from the ring post 100. A lock may be provided to secure the cabling to the ring post 100. In FIG. 7, the cabling is shown as rings and can be secured at one ring 120 of a ring post 100, or between rings 120 of adjacent ring posts 100. The cabling can extend straight or twist based upon the alignment of the ring posts 100.

In some embodiments, the recesses 112 of a ring post 100 correspond with the protuberances 114 of a second assembly, or an adjacent ring post 150. That is, when two ring posts are provided in a stacked configuration, such as those shown in FIG. 7, the recesses of one ring post 100 are configured to hold or engage the protuberances 114 of the adjacent ring post 150 therein, such that a relative angular orientation of the ring post 100 to the adjacent ring post 150 is thereby defined (e.g., to define ribs 130 that are aligned or offset between the ring post 100 and the adjacent ring post 150). Further, the legs 140A and detents 140 of one ring post 100 are able to be provided into (e.g., inserted within) the orifice 111 of the adjacent ring post 150 (the orifice of the adjacent ring post may also be referred to as a second orifice), allowing for a snap-fit connection between the ring post 100 and adjacent ring post 150 that provides a secure coupling arrangement (secure engagement), while also allowing separation (disengagement) if desired or needed, such as for relative repositioning. For example, the snap-fit ring posts 100, 150 may be detachable, such as by exerting pressure on a ring post 100 to disengage the ring post 100 from the adjacent ring post 150. Thus, adjacent ring posts 100, 150 may be easily detachable for maintenance purposes, or to aid in reassembling, repositioning the assembly, and so forth.

The configuration whereby the a plurality of protuberances 114 and recesses 112 of adjacent ring posts 100 mesh allows for the ring posts to be moved and turned with respect to each other, so as to improve maneuverability. Further, the snap-fit relationship of the legs 140A and detents 140 of one ring post 100 and the orifice 111 of the adjacent ring post 100 may improve the stackability of the ring posts and avoid the use of machining or tooling that would otherwise be necessary to manufacture and place a ring post assembly within a structure.

In some embodiments, the ring posts 100 may be fitted with a locking mechanism. The locking mechanism may be a part of the ring posts 100, or a separate device provided so as to ensure that the assembly of ring posts 100 is secured. Once secured, the ring posts 100 may have zero tolerance for twisting.

In some embodiments, the plurality of ring posts 100 may be arranged in an area of the airplane, such as an area that holds a substantial amount of wiring or cabling 200. The arrangement of the ring posts 100 may lead to a reduction in parts and also a weight reduction since the ring posts 100 can be stacked to an unlimited height or length, and double or triple ring posts will no longer be necessary, while still achieving the flexibility necessary to house the cabling 200.

In some embodiments, the number of protuberances 114 and recesses 112 can be chosen so as to ensure ease of engagement between adjacent ring posts, while also defining different relative angular orientations. Thus, while one protuberance 114 and one recess 112 may be sufficient, a plurality of protuberances 114 and recesses 112 may improve and simplify alignment techniques and for securing ring posts 100 stacked together.

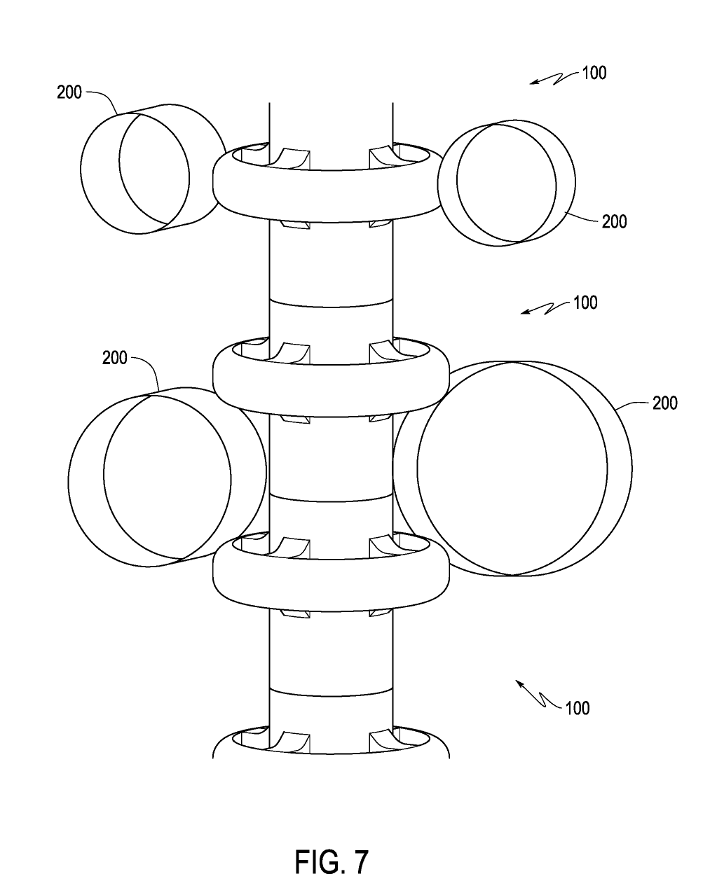

As described in FIG. 8, once connected, or even before being connected to each other, the assembly of ring posts 100 can house a cabling or wiring 200 therein. During, before or after the cabling is placed through the ring posts 100, the assembly of ring posts 100 housing the cabling 200 can be affixed to a support structure, such as a support structure of an airplane.

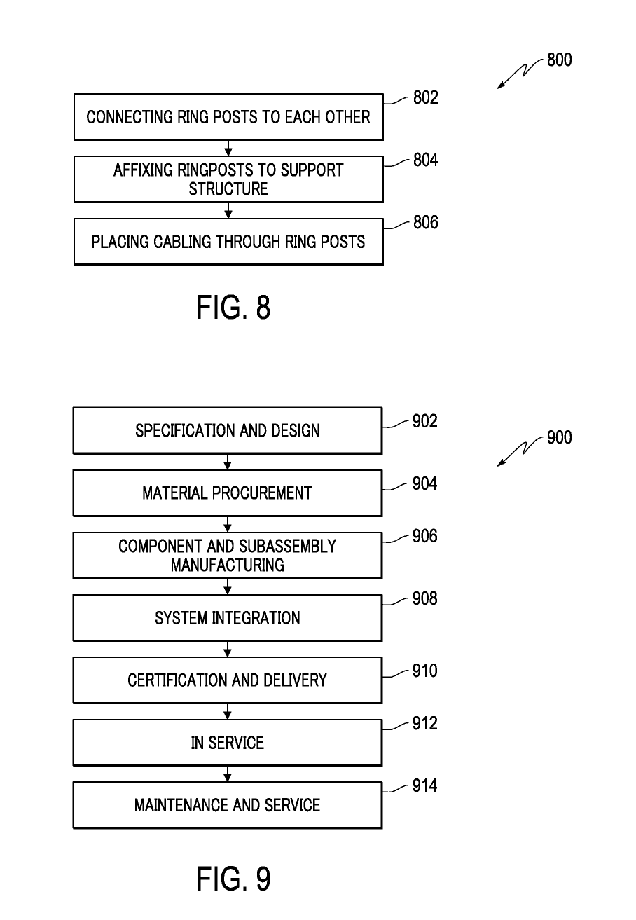

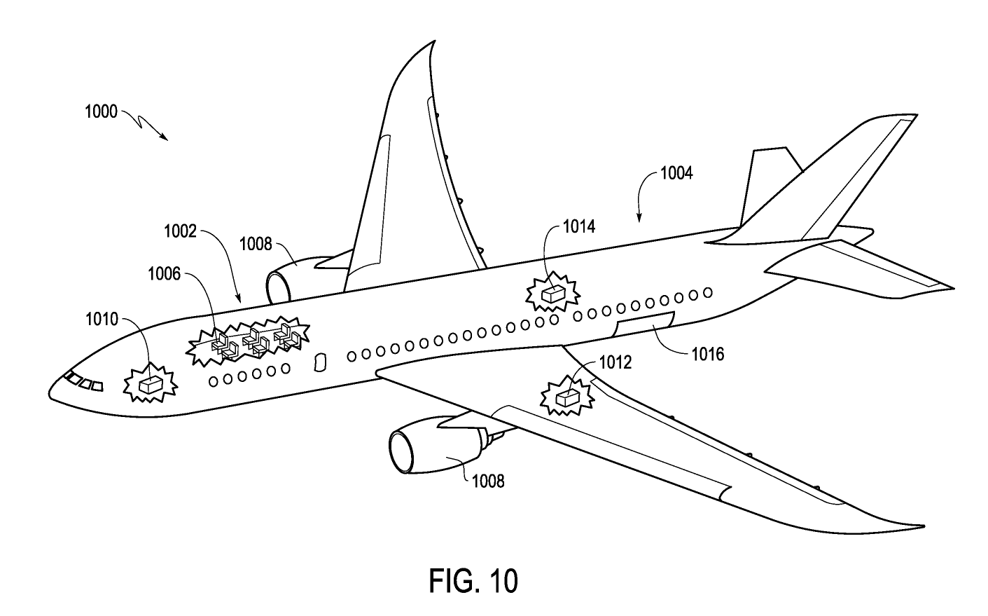

Examples of the disclosure may be described in the context of an aircraft manufacturing and service method 900 as shown in FIG. 9 and an aircraft 1000 as shown in FIG. 10. During pre-production, illustrative method 900 may include specification and design 902 of the aircraft 1000 and material procurement 904. During production, component and subassembly manufacturing 906 and system integration 908 of the aircraft 1000 take place. Thereafter, the aircraft 1000 may go through certification and delivery 910 to be placed in service 912. While in service by a customer, the aircraft 1000 is scheduled for routine maintenance and service 914 (which may also include modification, reconfiguration, refurbishment, and so on).

Each of the processes of the illustrative method 900 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown FIG. 10, the aircraft 1000 produced by the illustrative method 900 may include an airframe 1002 with a plurality of high-level systems 1004 and an interior 1006. Examples of high-level systems 1004 include one or more of a propulsion system 1008, an electrical system 1010, a hydraulic system 1012, and an environmental system 1014. Any number of other systems may be included. Although an aerospace example is shown, the principles may be applied to other industries, such as the automotive industry.

The disclosure and drawing figure(s) describing the operations of the method(s) set forth herein should not be interpreted as necessarily determining a sequence in which the operations are to be performed. Rather, although one illustrative order is indicated, it is to be understood that the sequence of the operations may be modified when appropriate. Accordingly, certain operations may be performed in a different order or simultaneously. Additionally, in some aspects of the disclosure, not all operations described herein need be performed.

Apparatus and methods shown or described herein may be employed during any one or more of the stages of the manufacturing and service method 900. For example, components or subassemblies corresponding to component and subassembly manufacturing 906 may be fabricated or manufactured in a manner similar to components or subassemblies produced while the aircraft 1000 is in service. Also, one or more aspects of the apparatus, method, or combination thereof may be utilized during the production states 906 and 908, for example, by substantially expediting assembly of or reducing the cost of an aircraft 1000. Similarly, one or more aspects of the apparatus or method realizations, or a combination thereof, may be utilized, for example and without limitation, while the aircraft 1000 is in service, e.g., maintenance and service 914.

Thus, various embodiments provide a scalable and stackable ring post arrangement that is easier to install and maintain, while also being lighter weight.

Different examples and aspects of the apparatus and methods are disclosed herein that include a variety of components, features, and functionality. It should be understood that the various examples and aspects of the apparatus and methods disclosed herein may include any of the components, features, and functionality of any of the other examples and aspects of the apparatus and methods disclosed herein in any combination, and all of such possibilities are intended to be within the spirit and scope of the present disclosure.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, paragraph (f), unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. An assembly, comprising:
a first device, comprising:
a main body; and
a ring disposed around the main body and defining a plurality of openings,
wherein the main body includes at least one protuberance and at least one recess, the at least one recess having a concave spherical shape, and
wherein the first device is configured to be coupled to an adjacent second device such that the at least one protuberance or the at least one recess engages with a portion of the adjacent second device.

2. The assembly according to claim 1, wherein the at least one protuberance has a convex spherical shape, and wherein a radius of curvature of the at least one recess is greater than a radius of curvature of the at least one protuberance.

3. The assembly according to claim 1, wherein a first end of the main body includes the at least one protuberance and an outer surface of a second end of the main body includes the at least one recess, wherein the at least one recess and at least one protuberance are complementary in number.

4. The assembly according to claim 1, wherein the first device further comprises:
a first orifice provided at a first end of the main body and a closed second end opposite the first end, and wherein the first orifice extends partially through the main body from the first end; and
at least one detent extending from the main body at the second end,
wherein the at least one detent is configured to be coupled to a second orifice of the adjacent second device.

5. The assembly according to claim 4, wherein the first device includes a leg between the main body and the at least one detent, the leg and detent configured to snap-fit to the second orifice of the adjacent second device.

6. The assembly according to claim 1, wherein the first device further comprises:
a plurality of ribs circumferentially spaced along an outer surface of the main body to secure the ring to the main body, the plurality of openings defined between the ribs.

7. The assembly according to claim 6, wherein a longitudinal thickness at the main body is a first longitudinal thickness and a longitudinal thickness at the ring is a second longitudinal thickness, the first longitudinal thickness being greater than the second longitudinal thickness.

8. The assembly according to claim 1, wherein the second device comprises:
a main body; and
a ring disposed around the main body,
wherein a first end of the main body is provided with at least one protuberance and a second end of the main body is provided with at least one recess.

9. The assembly according to claim 8, wherein the at least one recess of the first device is configured to engage the at least one protuberance of the second device to removably align the first device with the second device during use.

10. The assembly according to claim 8, wherein the second device further comprises:
an orifice provided at one first end of the main body; and
at least one detent extending from the main body at a second end opposite from the orifice.

11. The assembly according to claim 8, wherein at least one detent of the first device is configured to be coupled with an orifice of the second device.

12. The assembly according to claim 1, further comprising a plurality of protuberances each circumferentially spaced about a central axis of the main body on a first end of the main body and a plurality of recesses each circumferentially spaced about a central axis of the main body on a second end face of the main body, wherein each of the plurality of protuberances and recesses has a substantially circular cross-section.

13. The assembly according to claim 1, wherein the assembly is configured to be provided in an airplane.

14. The assembly according to claim 1, wherein the assembly is configured to receive cabling through the first device.

15. The assembly according to claim 1, wherein the main body comprises a plastic material.

16. An apparatus for securing at least one cable to a structure, the apparatus comprising:
a main body having a first end and a second end spaced from one another, the first end defining an orifice and the second end having a plurality of concave spherical recesses in a predetermined pattern along an outer surface a rim of the second end;
a plurality of protuberances extending from the first end, around the orifice, the protuberances being complementary to the plurality of concave spherical recesses in the second end for orienting the apparatus;
a ring disposed about the main body;
a plurality of ribs radially spaced along an outer surface of the main body coupling the ring and the main body to each other;
a plurality of legs extending from the second end; and
a detent disposed on each of the legs opposite the main body,
wherein the legs and detents are complementary to the configuration of the orifice defined by the first end of the main body.

17. The apparatus according to claim 16, wherein the second end of the main body is closed and the orifice extends partially through the main body from the first end, and wherein the orifice includes a space configured to secure the detents and legs of an adjacent apparatuses, the space establishing the complementary configuration to the legs and detent.

18. The apparatus according to claim 16, wherein the plurality of protuberances are disposed in a predetermined pattern along a rim of the first second end, wherein each of the plurality of the protuberances has a convex spherical shape.

19. A method for securing cabling in an airplane, comprising:
connecting a plurality of ring posts to each other, each ring post comprising a main body, a ring disposed around the main body, an orifice provided at one end of the main body, and at least one detent extending from the main body at an end opposite from the orifice, to each other, wherein the connecting of the plurality of ring posts includes placing protuberances of one of the plurality of the ring posts into concave spherical recesses of another of the plurality of ring posts;
placing detents of the one of the plurality of ring posts into the orifice of the other of the plurality of the ring posts, so as to provide a removable snap-fit assembly of ring posts; and
affixing the plurality of ring posts to a support structure of the airplane; and
placing cabling through the plurality of ring posts.

20. The method of claim 19, further comprising changing a relative angular orientation of two ring posts by rotating one ring post relative to another ring post to align different protuberances and recesses of the two ring posts.
